(19) United States
(12) Patent Application Publication
(10) Pub. No.: US 2026/0064466 A1
(43) Pub. Date: Mar. 5, 2026

(54) MANAGING USB DEVICES USING A MANAGEMENT CONTROLLER OF A DATA PROCESISNG SYSTEM

(71) Applicant: Dell Products L.P., Round Rock, TX (US)

(72) Inventors: VINODKUMAR VASUDEV OTTAR, McKinney, TX (US); GOKUL THIRUCHENGODE VAJRAVEL, Bangalore (IN); BASSEM EL-AZZAMI, Austin, TX (US); LUIS ANTONIO VALENCIA REYES, Waxahachie, TX (US); ABEYE TESHOME, Austin, TX (US); RICHARD M. TONRY, Georgetown, TX (US); MOHIT ARORA, Frisco, TX (US); ADOLFO SANDOR MONTERO, Pflugerville, TX (US); RAJARAVI CHANDRA KOLLARAPU, Allen, TX (US)

(21) Appl. No.: 18/820,667

(22) Filed: Aug. 30, 2024

(51) Int. Cl. G06F 9/50; G06F 13/42

(52) U.S. Cl. CPC G06F 9/5011; G06F 13/4282; G06F 2213/0026

(57) ABSTRACT

Methods and systems for managing operations of a data processing system are disclosed. To manage operations of the data processing system, a hardware resource of the data processing system may identify that a device is operably connected to the data processing system. A management controller of the data processing system may perform a screening procedure to determine whether the device is an any known good device. If the device is not the any known good device, the device may be denied access to the data processing system to reduce an impact of the device on the operation of the data processing system. If the device is the any known good device, the device may be allowed access to the data processing system to perform functions of the device. Computer-implemented services may be provided using the device.

### FIELD

Embodiments disclosed herein relate generally to managing operation of a data processing system. More particularly, embodiments disclosed herein relate to systems and methods to manage USB devices using a management controller of a data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating components of a data processing system in accordance with an embodiment.

FIG. 1C shows a block diagram illustrating components of a data processing system in accordance with an embodiment.

FIGS. 2A-2B show interaction diagrams in accordance with an embodiment.

FIG. 3 shows a flow diagram illustrating a method of managing a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services. To provide the computer-implemented services, the data processing system may include in-band hardware resources (e.g., memory modules, a processor).

While providing the computer-implemented services, the hardware resources may interact with any number and/or type of other devices operably connected to the data processing system, including universal serial bus (USB) devices. The USB devices may include devices used to exchange data (e.g., flash drives), store data (e.g., external hard drives), transfer power (e.g., power banks, chargers), add functionality to the data processing system (e.g., webcams, speakers), enable network connections (e.g., network interface controller (NIC) cards), and/or facilitate user interactions with the data processing system (e.g., mice, keyboards).

The data processing system may be adapted to automatically initiate operation of the USB devices upon operable connection to the data processing system (e.g., without the need for physical device configuration and/or user input). Because operation of the USB devices may be automatically initiated, a malicious entity may use a USB device to compromise the data processing system (e.g., by installing malware, by accessing data stored on the data processing system).

In order to reduce a likelihood of the data processing system becoming compromised by the malicious entity using the USB device, the data processing system may include functionality to screen USB devices using applications hosted by the hardware resources, such as a security program. However, the security program may become corrupted and/or may be inoperable (e.g., during a startup of the data processing system), which may result in the data processing system being vulnerable to potential security threats from the USB device.

To protect the data processing system from the potential security threats while allowing the USB devices to be used as desired by a user of the data processing system (e.g., including during the startup of the data processing system), screening of the USB devices may be performed using out-of-band components of the data processing system (e.g., a management controller). The management controller may perform a screening procedure to determine whether a USB device is any known good device (e.g., not any known bad device and/or any indeterminant device).

To perform the screening procedure, the management controller may monitor communications between the USB device and the hardware resources (e.g., via a USB controller) to obtain traffic data. The traffic data may be used to obtain at least one communication pattern between the USB device and the hardware resources, which may be analyzed by the management controller. The management controller may determine whether the traffic data is consistent with historical traffic patterns of the any known good device (e.g., by performing a similarity analysis using the at least one communication pattern and the historical traffic patterns). Based on the analyzing, a conclusion may be made regarding whether the USB device is the any known good device.

The management controller may also perform the screening procedure using a management controller agent (e.g., a software program) hosted by a hardware resource (e.g., a processor). The management controller agent may obtain device data (e.g., via an in-band communication channel of the data processing system), which may be usable to identify at least a type of the device (e.g., a mouse, a flash drive). Using the device data, a class of device (e.g., known good, known bad, indeterminant) may be identified based on associations between types of devices and classes of devices. Based on the class of device, a conclusion may be made regarding whether the USB device is the any known good device.

If it is concluded during the screening procedure that the USB device is the any known good device, the USB device may be allowed access to the data processing system to perform functions of the USB device. Computer-implemented services may then be provided using the USB device. If it is concluded during the screening procedure that the USB device is not the any known good device (e.g., any known bad device and/or any indeterminant device), the USB device may be denied access to the data processing system to reduce an impact of the USB device on the operation of the data processing system.

Thus, embodiments disclosed herein may address, among other technical problems, the technical challenge of screening USB devices for potential security threats. By using a management controller to perform a screening procedure (e.g., rather than a software program hosted by hardware resources), the screening procedure may be performed without relying on potentially compromised and/or inoperable in-band components. For example, the screening procedure may be performed by the management controller during a startup of the data processing system, during which time security programs used to screen USB devices may be unavailable (e.g., due to the operating system not being booted). Thus, the USB devices may be screened and used in the provision of computer-implemented services with a reduced likelihood of compromising the data processing system.

In an embodiment, a method for managing operation of a data processing system is disclosed. The method may include: identifying, by a hardware resource of hardware resources of the data processing system, that a device is operably connected to the data processing system; performing, using a management controller of the data processing system, a screening procedure to determine whether the device is any known good device; in a first instance of the screening procedure in which the device is not the any known good device: denying the device access to the data processing system to reduce an impact of the device on the operation of the data processing system; in a second instance of the screening procedure in which the device is the any known good device: allowing the device access to the data processing system to perform functions of the device; and providing, using the device, computer-implemented services.

Performing the screening procedure may include: obtaining, by the management controller and via a sideband channel of the data processing system, traffic data, the traffic data being usable to obtain communication patterns between the device and the hardware resources; analyzing, by the management controller and using at least one communication pattern, the traffic data to determine whether the traffic data is consistent with historical traffic patterns of the any known good device; and making a conclusion, based on the analyzing, regarding whether the device is the any known good device.

Obtaining the traffic data may include: intercepting commands sent from the device to the hardware resources prior to being received by a destination component of the hardware resources; obtaining, using the communications, metadata regarding characteristics of the communications; and obtaining, based on the metadata, the at least one communication pattern.

The communications sent from the device may not be provided to the destination component of the hardware resources until completion of the screening procedure.

Performing the screening procedure may include: obtaining, by a management controller agent hosted by the hardware resources and via an in-band communication channel, device data, the device data being usable to identify at least a type of the device; providing, via a sideband channel of the data processing system, the device data to the management controller; identifying a class of device using the device data, the class of device being associated with the type of the device; and making a conclusion, based on the class of device, regarding whether the device is the any known good device.

The any known good device may include a device that is not an any known bad device and is not any indeterminant device.

The any known good device may exhibit a level of risk that the device will act maliciously towards the data processing system that meets criteria, and the any known bad device and the any indeterminant device may exhibit levels of risk that such devices will act maliciously towards the data processing system that does not meet the criteria.

The management controller may be on a separate power domain from the hardware resources so that the management controller is operable while the hardware resources are inoperable.

The screening procedure may be performed during a startup of the data processing system.

The hardware resources may be adapted to interact with the device during the startup when not precluded from doing so by the management controller.

The hardware resources may be in a low security state during the startup such that the hardware resources are not in a condition to screen the device for potential security threats.

The management controller may be separate from and tasked with managing operation of the hardware resources, and commands issued by the management controller may override commands issued by the hardware resources.

The device may be a universal serial bus (USB) device, and a management entity of the data processing system may be adapted to automatically initiate operation of the device upon identification that the device is operably connected to the data processing system when not precluded from doing so by the management controller.

The hardware resource may be a USB controller, and the device may be operably connected to the data processing system via a USB receptacle.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

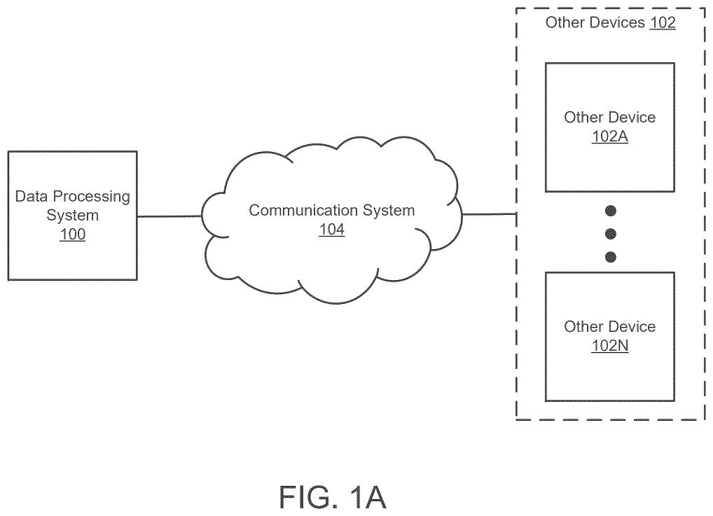

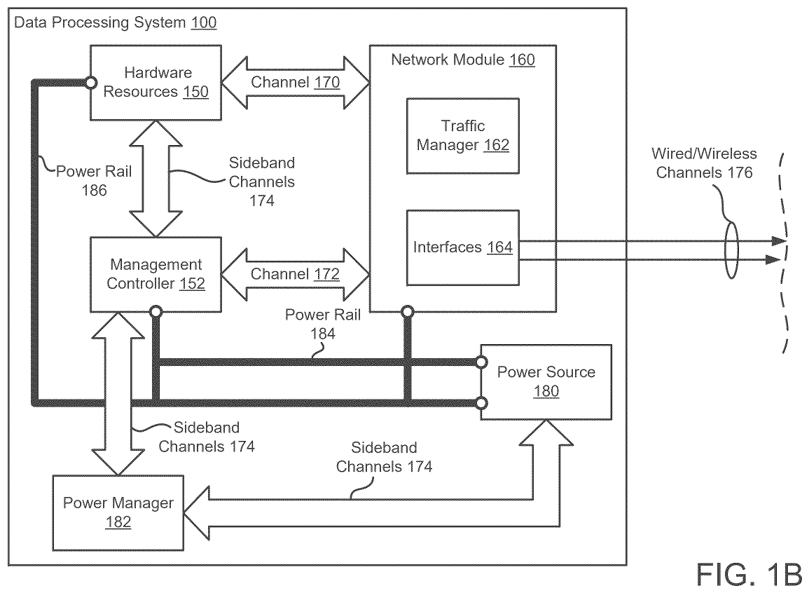

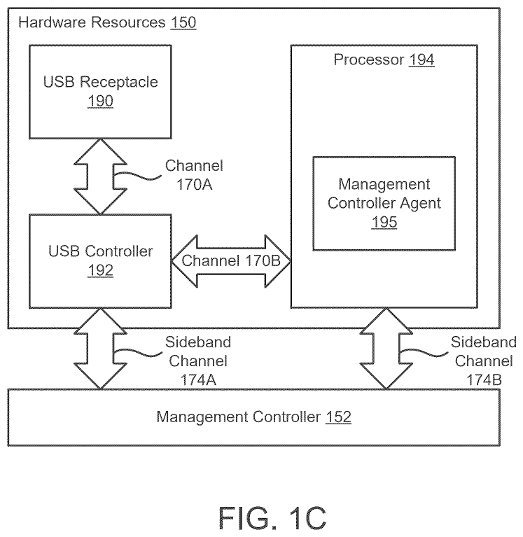

Turning to FIG. 1A, a block diagram illustrating a system in accordance with an embodiment is shown. The system shown in FIG. 1A may provide for management of a data processing system that may provide, at least in part, computer-implemented services. The computer-implemented services may include any type and quantity of services including, for example, data services (e.g., data storage, access, and/or control services), communication services (e.g., instant messaging services, video-conferencing services), and/or any other type of service that may be implemented with a computing device. Other types of computer-implemented services may be provided by the system shown in FIG. 1A without departing from embodiments disclosed herein.

The data processing system may include any number of in-band components, such as hardware resources (e.g., processors, memory modules, storage devices, communication devices). The hardware resources may support execution of any number and type of applications (e.g., software components). Changes in available functionalities of hardware resources and/or software components may provide for various types of different computer-implemented services to be provided over time.

To provide the computer-implemented services, the hardware resources may interact with any number and type of other devices operably connected to the data processing system, including universal serial bus (USB) devices. For example, USB devices may include devices used to exchange data (e.g., flash drives), store data (e.g., external hard drives), transfer power (e.g., power banks, chargers), and/or add functionality to the data processing system (e.g., webcams, speakers). Additionally, USB devices may facilitate provision of computer-implemented services by enabling network connections (e.g., network interface controller (NIC) cards), and/or via the addition of tangible user interface devices (e.g., mice, keyboards).

A management entity of the data processing system, such as an operating system, may be adapted to automatically initiate operation of the USB devices upon establishment of an operable connection to the data processing system (e.g., without the need for physical device configuration and/or user input). However, because the operation of the USB devices may be initiated automatically, the USB devices may pose a security risk for the data processing system. For example, a malicious entity may attempt to use a USB device to transmit malware to the data processing system, access data stored on the data processing system, and/or perform other unauthorized tasks without permission from a user of the data processing system. Thus, the malicious entity may compromise the data processing system using the USB device.

To reduce a likelihood of becoming compromised, the data processing system may include applications such as a security program (e.g., hosted by the hardware resources) to screen USB devices for potential security threats. The security program may be executed upon detection of the USB device and/or may monitor USB devices continuously, and may scan files on the USB device for known viruses and/or other types of malware. If the security program detects a virus and/or other malware, remedial actions, such as quarantining or deleting infected files, may be performed.

However, the security program may become corrupted and/or may be inoperable, resulting in an inability to perform its functionality. For example, the security program may become corrupted due to an alteration in the configuration of a file used by the program. In another example, the security program may be inoperable during a startup of the data processing system (e.g., due to the operating system not being booted). As a result, the data processing system may be vulnerable to compromise by the malicious entity. Compromise by the malicious entity may result in an inability of the data processing system to provide at least a portion of the computer-implemented services.

To protect the data processing system from compromise in instances when the security program is unable to perform its functionality (e.g., during the startup), the data processing system may be configured to restrict use of USB devices. For example, the data processing system may be configured to disable use of any type of USB device during the startup. However, disabling use of USB devices during the startup may negatively impact the data processing system. For example, the data processing system may be unable to boot the operating system from a USB device (e.g., an external hard drive and/or flash drive) during the startup and/or may be unable to use a USB device (e.g., a NIC card) to establish a network connection necessary to perform the startup. Consequently, the computer-implemented services provided by the data processing system may be interrupted, delayed, and/or of a reduced quality.

In general, embodiments disclosed herein may provide methods, systems, and/or devices for managing operation of a data processing system in a manner that facilitates use of USB devices using out-of-band components of the data processing system (e.g., a management controller). To facilitate use of a USB device, the management controller may perform a screening procedure to determine whether the USB device is any known good device. The any known good device may be a device which is not an any known bad device and/or any indeterminant device, and may exhibit a level of risk that the device will act maliciously towards the data processing system that meets criteria.

To perform the screening procedure, the management controller may obtain traffic data by monitoring communications between the USB device and hardware resources of the data processing system (e.g., using a USB controller and via a sideband channel of the data processing system). The traffic data may be used to obtain at least one communication pattern between the USB device and the hardware resources, which may be analyzed by the management controller. The management controller may determine whether the traffic data is consistent with historical traffic patterns of the any known good device (e.g., by performing a similarity analysis using the at least one communication pattern and the historical traffic patterns). Based on the analyzing, a conclusion may be made regarding whether the USB device is the any known good device.

The management controller may also perform the screening procedure using, at least in part, a management controller agent (e.g., a software program) hosted by a hardware resource (e.g., a processor). The management controller agent may obtain device data (e.g., via an in-band communication channel), which may be usable to identify at least a type of the device (e.g., a mouse, a flash drive). Using the device data, a class of device (e.g., known good, known bad, indeterminant) may be identified based on associations between types of devices and classes of devices. Based on the class of device, a conclusion may be made regarding whether the USB device is the any known good device.

If it is concluded during the screening procedure that the USB device is the any known good device, the USB device may be allowed access to the data processing system to perform functions of the USB device. Computer-implemented services may then be provided using the USB device. If it is concluded during the screening procedure that the USB device is not the any known good device (e.g., the USB device is any known bad device and/or any indeterminant device), the USB device may be denied access to the data processing system to reduce an impact of the USB device on the operation of the data processing system.

By doing so, a system in accordance with an embodiment may increase a likelihood of preventing potentially malicious USB devices from accessing the data processing system by using out-of-band components (e.g., a management controller). The management controller may perform a screening procedure to determine whether a USB device is any known good device without relying on in-band hardware components and/or applications hosted thereon, which may become compromised and/or disabled. As a result, USB devices may be used by the data processing system to provide computer-implemented services, which may increase a likelihood of the computer-implemented services being provided to downstream consumers of the services as desired.

To perform the above-mentioned functionality, the system of FIG. 1A may include data processing system 100, other devices 102, and communication system 104. Data processing system 100, other devices 102, any components thereof and/or any other types of devices or components not shown in FIG. 1A may perform all, or a portion of the computer-implemented services independently and/or cooperatively. Each of these components is discussed below.

Data processing system 100 may include any number and/or type of data processing systems used to provide computer-implemented services. To provide the computer-implemented services, data processing system 100 may include out-of-band components (e.g., a network module, a management controller) and functionality that may allow data exchange between the out-of-band components independently from in-band components (e.g., hardware resources) of data processing system 100. For additional details regarding out-of-band components of data processing system 100, refer to the discussion of FIG. 1B.

While providing the computer-implemented services, components of data processing system 100 may interact with other devices 102. Other devices 102 may include any number and/or type of devices (e.g., 102A-102N). Other devices 102 may include USB devices which are accessible to and controlled by data processing system 100 after establishing an operable connection to data processing system 100. Upon establishing the operable connection, a management entity of data processing system 100, such as an operating system, may automatically initiate operation of other devices 102 (e.g., when not precluded from doing so by the management controller). For additional details regarding interactions between the components of data processing other devices 102, refer to the discussion of FIG. 1C.

Interactions between other devices 102 and data processing system 100 may be managed by the management controller of data processing system 100, which may provide device security management services. The device security management services may include screening other devices 102 operably connected to data processing system 100 to identify potential security threats. To provide the device security management services, the management controller may perform a screening procedure to determine whether a device (e.g., other device 102A) is any known good device.

To perform the screening procedure, the management controller may (i) obtain traffic data via a sideband channel of data processing system 100 (e.g., by intercepting communications sent from other device 102A to a destination component of the hardware resources), (ii) analyze the traffic data to determine whether the traffic data is consistent with historical traffic patterns of the any known good device (e.g., by obtaining metadata regarding characteristics of the communications, obtaining at least one communication pattern based on the metadata, comparing the at least one communication pattern to historical traffic patterns), (iii) make a conclusion regarding whether other device 102A is the any known good device (e.g., based on the analyzing), and/or (iv) perform other tasks.

The management controller may be distinct from and/or may operate independently from the hardware resources. To facilitate cooperation between the hardware resources and the management controller, the hardware resources (e.g., a processor) may host an agent for the management controller (e.g., a management controller agent). The management controller agent (e.g., a software program) may facilitate communication between the management controller and the hardware resources. The management controller agent may also be used, at least in part, in performing the screening procedure.

To use the management controller agent in performing the screening procedure, the management controller agent may (i) obtain device data via an in-band communication channel (e.g., including identifying information such as a serial number, a manufacturer of other device 102A), (ii) identify a type of other device 102A using the device data, (iii) provide the device data, the type of other device 102A, and/or other data to the management controller so that the management controller is able to make a conclusion regarding whether other device 102A is the any known good device (e.g., based on the type of other device 102A and/or other information from the device data), and/or (iv) perform other tasks. For additional details regarding the management controller agent, refer to the discussion of FIG. 1C.

Thus, device security management services for a data processing system may be provided using out-of-band methods (e.g., using out-of-band components such as a management controller). By doing so, other devices, such as USB devices, may be screened for potential security threats without relying on potentially compromised and/or inoperable in-band components. As a result, there may be an increased likelihood that potentially malicious devices are detected, which may allow remedial actions to be taken (e.g., preventing the device from accessing the data processing system). Thus, the data processing system may have a reduced likelihood of becoming compromised, which may allow computer-implemented services to be provided by the data processing system.

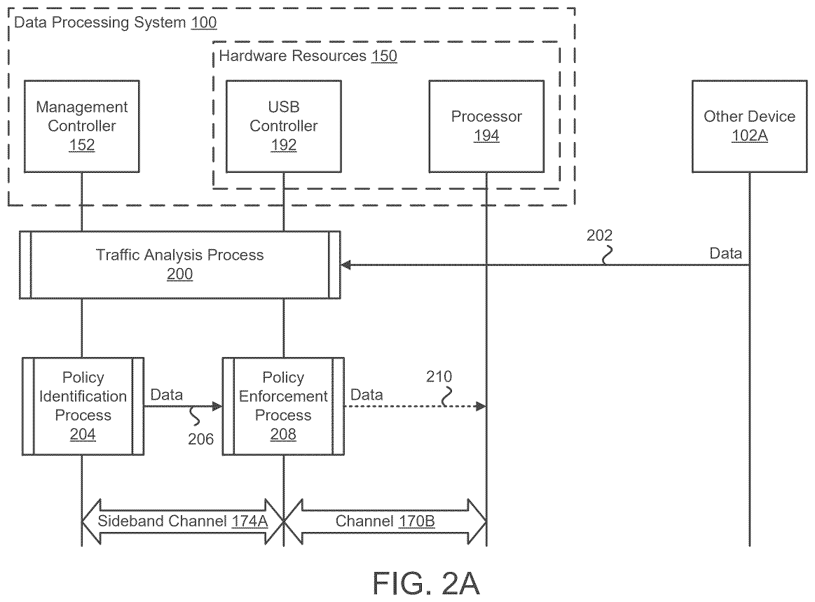

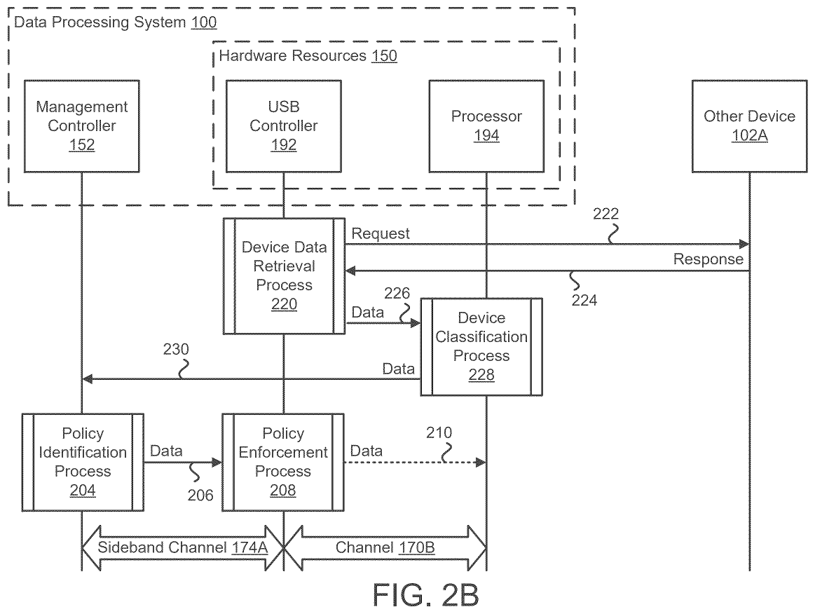

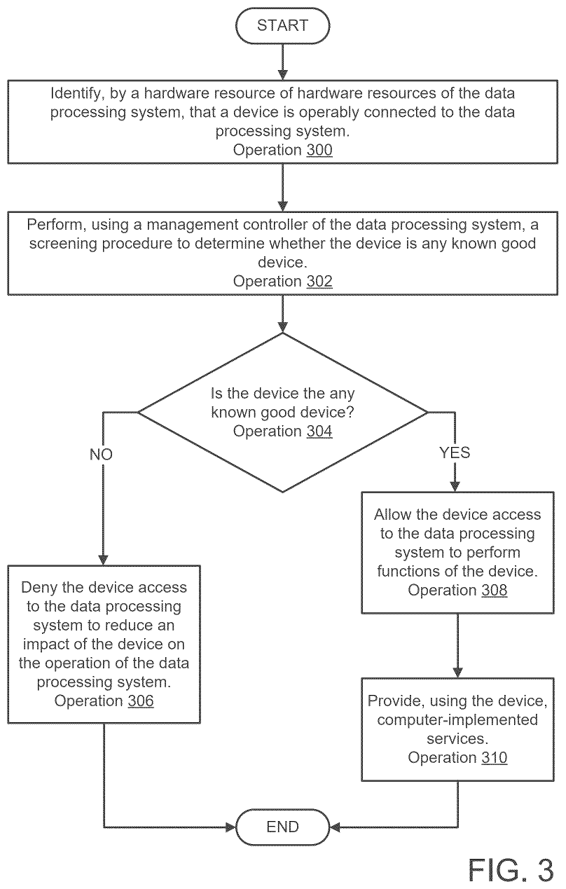

When providing their functionality, any components of data processing system 100 and/or other devices 102 may perform all, or a portion of the actions and methods illustrated in FIGS. 2A-3.

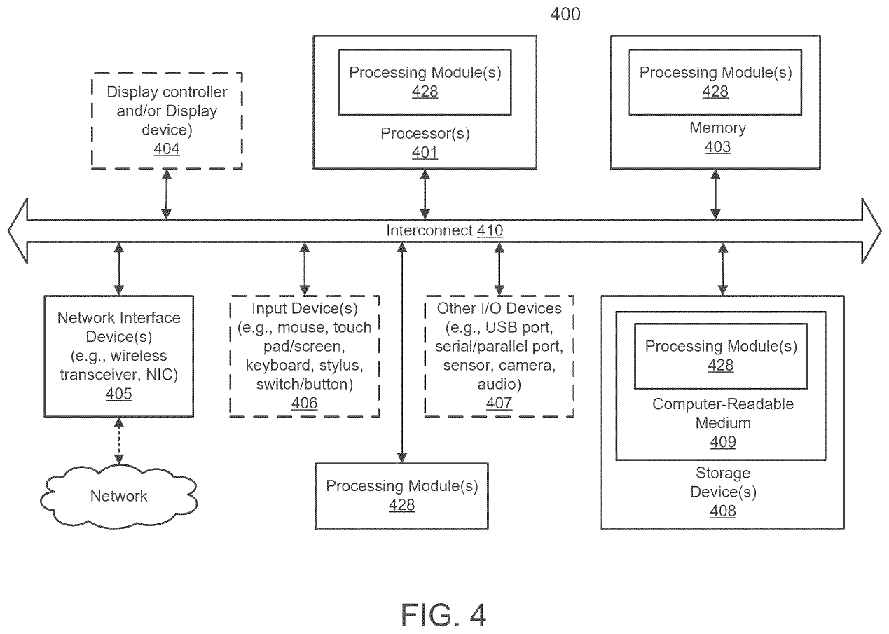

Any of data processing system 100 (and/or components thereof) and/or other devices 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 104. Communication system 104 may facilitate communications between the components of FIG. 1A. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein. For example, while the system of FIG. 1A shows a single data processing system (e.g., 100), it will be appreciated that the system may include any number of data processing systems.

Turning to FIG. 1B, a diagram illustrating components of a data processing system in accordance with an embodiment is shown. The components of the data processing system shown in FIG. 1B may be similar to those of data processing system 100 in FIG. 1A.

To provide computer-implemented services, data processing system 100 may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100) to another device via any number of intermediate networks (e.g., via wired/wireless channels 176 that are part of the networks).

To reduce the likelihood of the applications and/or other in-band entities from being indirectly compromised, data processing system 100 may include management controller 152 and network module 160. Each of these components of data processing system 100 is discussed below.

Management controller 152 may be implemented, for example, using a system on a chip or other type of independently operating computing device (e.g., independent from the in-band components, such as hardware resources 150, of a host data processing system 100). Management controller 152 may be separate from and tasked with managing operation of hardware resources 150. To do so, management controller 152 may issue commands to various components of hardware resources 150. The commands issued by management controller 152 may override commands issued by hardware resources 150. For example, if management controller 152 issues a command to a USB controller of data processing system 100 which conflicts with a command issued by the processor, the command issued by management controller 152 may be performed.

Management controller 152 may provide various management functionalities for data processing system 100. For example, management controller 152 may monitor various ongoing processes performed by the in-band components, may manage power distribution, may participate in thermal management, and/or other may perform other functions, such as screening other devices operably connected to data processing system 100 for potential security threats.

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as 174A shown in FIG. 1C). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, sideband channels 174 may facilitate communications between management controller 152 and hardware resources 150 so that management controller 152 may obtain data usable to screen other devices for potential security threats. Additionally, management controller 152 may use sideband channels 174 to exchange data with a management controller agent hosted by hardware resources 150. For additional details regarding the management controller agent, refer to FIG. 1C.

To reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 100 via separate channels (e.g., 172) from the in-band components, and may implement or otherwise utilize a distinct and independent network stack (e.g., TCP/IP). Consequently, management controller 152 may communicate with other devices independently of any portion of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100 may include network module 160. Network module 160 may provide communication services for in-band components and out-of-band components (e.g., management controller 152) of data processing system 100. To do so, network module 160 may include traffic manager 162 and interfaces 164.

Traffic manager 162 may include functionality to (i) discriminate traffic directed to various network endpoints advertised by data processing system 100, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a Wi-Fi card, a wireless local area network card, a wired local area network card, an optical communication card, and/or other types of communication components. These components may support any number of wired/wireless channels 176.

Thus, from the perspective of an external device, the in-band components and the out-of-band components of data processing system 100 may appear to be two independent network entities that may independently addressable and otherwise unrelated to one another.

To facilitate management of data processing system 100 over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while all or a portion of hardware resources 150 is unpowered (e.g., during a startup of data processing system 100). Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons. For example, management controller 152 may screen other devices for potential security threats during the startup of data processing system 100, even when portions of hardware resources 150 (e.g., including the operating system hosted thereon) have not been booted.

To implement the separate power domains, data processing system 100 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, and power may be supplied via the power rails. Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

While illustrated in FIG. 1B with a limited number of specific components, a system may include additional, fewer, and/or different components without departing from embodiments disclosed herein.

Turning to FIG. 1C, a diagram illustrating components of a data processing system in accordance with an embodiment is shown. The components of the data processing system shown in FIG. 1C may be similar to those of data processing system 100 in FIGS. 1A-1B.

To provide computer-implemented services, hardware resources 150 may include USB receptacle 190, USB controller 192, and processor 194. USB receptacle 190 may include any number, size, and/or type of mechanical connectors (e.g., USB Type-C, USB Micro-B) which correspond to USB plugs. USB receptacle 190 may be used to establish a connection between a device and data processing system 100 by inserting a corresponding USB plug from the device into USB receptacle 190.

To facilitate use of the USB device after the connection to data processing system 100 has been established, hardware resources 150 may include USB controller 192. USB controller 192 may detect the connection of the device (e.g., via in-band channel 170A), and may perform tasks to manage the exchange of data and power between data processing system 100 and the device. To perform its functionality, USB controller 192 may (i) manage USB protocols (e.g., manage packet generation, error checking, and handshaking to ensure data transmission and reception according to USB standard), (ii) facilitate data transfer between data processing system 100 and the device (e.g., manage various transfer modes such as control, bulk, interrupt, and isochronous transfers), (iii) manage power transfer (e.g., control power delivery to USB devices, manage power states to conserve energy), (iv) manage device enumeration processes (e.g., detect the connection of the device, determine communication speeds, load necessary drivers), and/or (v) perform other tasks.

As part of facilitating data transfer between data processing system 100 and the device, USB controller 192 may forward data from the device to a destination hardware component of hardware resources 150 (e.g., a processor, a storage device). For example, USB controller 192 may forward data to processor 194 (e.g., via in-band communication channel 170B). Processor 194 may read and execute instructions (e.g., from the device), and may host various management entities such as an operating system and/or management controller agent 195.

Management controller agent 195 may be hosted by processor 194 to facilitate cooperation between management controller 152 and any number of hardware components of hardware resources 150. Management controller agent 195 may be independent from other management entities (e.g., the operating system), and may facilitate communication with and performance of instructions by management controller 152.

For example, management controller agent 195 may include functionality to (i) monitor processes performed by hardware resources 150, (ii) obtain data from hardware resources 150 and/or other devices operably connected to data processing system 100, (iii) provide commands from management controller 152 to hardware resources 150, and/or (iv) perform other types of management actions. Management controller agent 195 may communicate with management controller 152 via a sideband channel (e.g., 174B).

Management controller 152 may communicate with management controller agent 195 to collect information regarding the USB device, and/or management controller 152 may communicate with USB controller 192 (e.g., via sideband channel 174A). For example, management controller 152 may receive a notification from USB controller 192 indicating the connection of the USB device. Management controller 152 may use USB controller 192 to intercept data from the USB device prior to being received by a destination component of hardware resources 150.

Using the information collected from USB controller 192 and/or management controller agent 195 regarding the USB device, management controller 152 may determine whether the device is allowed access to data processing system 100 (e.g., if the device is an any known good device). Based on the determination, management controller 152 may identify and enforce a corresponding policy. Enforcing the policy may include providing commands to USB controller 192 (e.g., via sideband channel 174A) regarding interactions with the USB device. Refer to FIGS. 2A-2B for additional details regarding policy identification and enforcement.

While illustrated in FIG. 1C with a limited number of specific components, a system may include additional, fewer, and/or different components without departing from embodiments disclosed herein.

To further clarify embodiments disclosed herein, interaction diagrams in accordance with an embodiment are shown in FIGS. 2A-2B. The interaction diagrams may illustrate examples of how data may be obtained and used within the systems of FIGS. 1A-1C. In the examples shown in FIGS. 2A-2B, a data processing system (e.g., 100) may include components such as hardware resources 150 and management controller 152. Hardware resources 150 may include USB controller 192 and processor 194. Processor 194 may host management controller agent 195 (not shown). The components of the data processing system may be similar to and/or include functionality similar to those described with respect to FIGS. 1A-1C.

In the interaction diagrams, processes performed by and interactions between components of a system in accordance with an embodiment are shown. In the diagram, components of the system are illustrated using a first set of shapes (e.g., 152, 192, etc.), located towards the top of each figure. Lines descend from these shapes. Processes performed by the components of the system are illustrated using a second set of shapes (e.g., 200, 204, etc.) superimposed over these lines.

Interactions (e.g., communications, data transmissions, etc.) between the components of the system are illustrated using a third set of shapes (e.g., 202, 206, etc.) that extend between the lines. The third set of shapes may include lines terminating in an arrow. Lines terminating in an arrow may indicate that one-way interactions (e.g., data transmission from a first component to a second component) occur. Lines terminating in an arrow may be shown in dashing to indicate the interaction is optional and/or may occur under certain conditions.

Generally, the processes and interactions are temporally ordered in an example order, with time increasing from the top to the bottom of each page. For example, the interaction labeled as 202 may occur prior to the interaction labeled as 206. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate data used in and data processing performed in performing at least a portion of a screening procedure by management controller 152. The screening procedure may be performed to determine whether a device operably connected to data processing system 100 (e.g., other device 102A) is any known good device. The screening procedure may be performed by (i) obtaining, by management controller 152, traffic data, (ii) analyzing the traffic data, and/or (iii) making a conclusion, based on the analyzing, regarding whether other device 102A is the any known good device. Based on the screening procedure, a policy may be identified and enforced.

Performance of the screening procedure may be initiated by identifying, by a hardware resource of hardware resources 150, that other device 102A is operably connected to data processing system 100. For example, USB controller 192 may detect the connection of other device 102A (e.g., via USB receptacle 190, not shown) and may notify management controller 152.

The screening procedure may be performed by management controller 152 during a startup of data processing system 100. For example, other device 102A may include an external hard drive used to store an operating system, and a user of data processing system 100 may desire to load the operating system from the external hard drive during the startup. Prior to loading the operating system from the external hard drive, management controller 152 may perform the screening procedure to screen the external hard drive for potential security threats.

Management controller 152 may perform the screening procedure during the startup due to hardware resources 150 being in a low security state during the startup such that hardware resources 150 are not in a condition to screen other device 102A for potential security threats. For example, during the startup security programs and/or other device screening software may be inoperable (e.g., due to the operating system not being booted).

To enable performance of the screening procedure during the startup, at least a portion of hardware resources 150 (e.g., USB receptacle 190 (not shown), USB controller 192) may be adapted to interact with other device 102A during the startup (e.g., when not precluded from doing so by management controller 152). Thus, USB controller 192 may be in a condition to detect the connection of other device 102A during startup and provide a notification regarding the connection to management controller 152.

Upon receiving the notification by management controller 152, traffic analysis process 200 may be performed. During traffic analysis process 200, traffic data may be obtained by management controller 152. The traffic data may include information regarding communications sent from other device 102A and may be usable to obtain communication patterns between other device 102A and hardware resources 150.

To obtain the traffic data, communications sent from other device 102A to hardware resources 150 may be intercepted by management controller 152 prior to being received by a destination component of hardware resources 150. For example, other device 102A may attempt to send communications (e.g., data) to the destination component (e.g., processor 194, a memory module) at interaction 202. The communications may be provided to USB controller 192 via an in-band communication channel (e.g., channel 170A) by (i) transmission via a message, (ii) storing in a storage with subsequent retrieval by USB controller 192, (iii) a publish-subscribe system where USB controller 192 subscribes to updates from other device 102A thereby causing a copy of the communications to be propagated to USB controller 192, and/or (iv) other processes.

Rather than forwarding the communications to the destination component, USB controller 192 may quarantine the communications (e.g., may store the communications in a local memory and/or otherwise prevent the communications from being received by the destination component). USB controller 192 may continue to quarantine the communications sent from other device 102A until completion of the screening procedure.

The communications quarantined by USB controller 192 may be used by management controller 152 to obtain metadata regarding characteristics of the communications (e.g., a time the communications were sent, a size of the communications, the destination component). Management controller 152 may obtain the metadata by (i) receiving a copy of the communications from USB controller 192 (e.g., via sideband channel 174) and reading the metadata included in the communications, (ii) generating the metadata based on an analysis of the communications (e.g., by generalizing characteristics from the communications), and/or (iii) other methods.

Based on the metadata, management controller 152 may obtain at least one communication pattern. Management controller 152 may obtain the at least one communication pattern by performing an analysis process using the metadata to identify trends. The identified trends may be compared to known communication patterns (e.g., from a database), and the at least one communication pattern may be selected from the known communication patterns which is correlated with the identified trends.

Continuing with the above example, other device 102A may include an external hard drive which may begin sending communications including commands intended for processor 194 once connected to data processing system 100. The communications may be quarantined by USB controller 192, and metadata regarding characteristics of the communications may be obtained by management controller 152. Using the metadata, management controller 152 may obtain two communications patterns. A first communication pattern may indicate that the communications occurred immediately after device plug in without being prompted by data processing system 100. A second communication pattern may indicate that the communications occurred repeatedly.

Using the at least one communication pattern, management controller 152 may analyze the traffic data to determine whether the traffic data is consistent with historical traffic patterns of any known good device. The any known good device may include a device that is not an any known bad device and is not any indeterminant device. For example, the any known good device may exhibit a level of risk that the device will act maliciously towards data processing system 100 that meets criteria, and the any known bad device and the any indeterminant device may exhibit levels of risk that such devices will act maliciously towards data processing system 100 that does not meet the criteria.

For example, the any known good device may include types of devices which are deemed unlikely to act maliciously towards data processing system 100 based on criteria, such as tangible user interface devices (e.g., mice, keyboards). The any known bad device may include types of devices which are deemed likely to act maliciously towards data processing system 100 based on criteria, such as devices known to host malware (e.g., known compromised flash drives). Types of devices which are neither known good devices nor known bad devices may be classified as indeterminant devices, which may be treated as likely to act maliciously towards data processing system 100.

Analyzing the traffic data to determine whether the traffic data is consistent with historical traffic patterns of the any known good device may include performing any number and/or type of similarity analyses and comparing outcomes of the analyses to similarity criteria. For example, a clustering analysis may be performed using the traffic data to determine whether the at least one communication pattern falls within a cluster of communication patterns of known good devices. If the at least one communication pattern does not fall within the cluster of communication patterns of known good devices, it may be concluded that other device 102A is not the any known good device. If the at least one communication pattern does fall within the cluster of communication patterns of known good devices, it may be concluded that other device 102A is the any known good device.

Continuing the above example, management controller 152 may analyze the traffic data from the external hard drive to determine whether is it consistent with historical traffic patterns of the any known good device using, for example, a clustering analysis. The clustering analysis may be used to determine that the two communication patterns exhibited by the external hard drive are not consistent with communication patterns of known good devices. Thus, management controller 152 may determine the external hard drive is not the any known good device.

Once a determination is made by management controller 152 regarding whether other device 102A is the any known good device, policy identification process 204 may be performed. During policy identification process 204, management controller 152 may identify a policy based on the determination. In a first example, if the device is the any known good device, the policy may include allowing other device 102A access to data processing system 100 to perform functions of other device 102A. In a second example, if the device is not the any known good device, the policy may include denying other device 102A access to data processing system 100 to reduce an impact of other device 102A on the operation of data processing system 100.

Upon identification of the policy, management controller 152 may provide data including instructions for enforcing the policy to USB controller 192 at interaction 206 (e.g., via sideband channel 174A). The data may be provided by (i) transmission via a message, (ii) storing in a storage with subsequent retrieval by USB controller 192, (iii) a publish-subscribe system where USB controller 192 subscribes to updates from management controller 152 thereby causing a copy of the data to be propagated to USB controller 192, and/or (iv) other processes.

The data may include an action set to be performed by USB controller 192 based on the policy. For example, if the policy indicates other device 102A is allowed access to data processing system 100, the action set may include (i) forwarding any quarantined communications from other device 102A to the destination component, (ii) providing a notification to other device 102A indicating other device 102A has been allowed access to data processing system 100, (iii) continuing to facilitate communication between other device 102A and hardware resources 150, and/or (iv) other actions. If the policy indicates other device 102A is denied access to data processing system 100, the action set may include (i) ignoring future communications from other device 102A, (ii) quarantining communications from other device 102A, (iii) providing a notification to other device 102A indicating other device 102A has been denied access to data processing system 100, and/or (iv) other actions.

The data may be used to perform policy enforcement process 208. During policy enforcement process 208, USB controller 192 may perform the action set. If action set includes instructions to forward quarantined communications from other device 102A to the destination component, the communications may be provided to the destination component.

For example, if the destination component is processor 194, the communications (e.g., data) may be provided to processor 194 at interaction 210 via in-band communication channel 170B. The communications may be provided by (i) transmission via a message, (ii) storing in a storage with subsequent retrieval by processor 194, (iii) a publish-subscribe system where processor 194 subscribes to updates from USB controller 192 thereby causing a copy of the communications to be propagated to processor 194, and/or (iv) other processes. By doing so, other device 102A may be used in the provision of computer-implemented services by data processing system 100.

Thus, the processes and interactions shown in FIG. 2A may be used to perform a screening procedure by management controller 152 to determine whether other device 102A is any known good device. Performing the screening procedure may include obtaining and analyzing traffic data. Based on the analyzing, a determination may be made regarding whether other device 102A is the any known good device, and a corresponding policy may be identified and enforced.

Turning to FIG. 2B, a second interaction diagram in accordance with an embodiment is shown. The second interaction diagram may illustrate data used in and data processing performed in performing at least a portion of a screening procedure by management controller 152. The screening procedure may be performed to determine whether a device operably connected to data processing system 100 (e.g., other device 102A) is any known good device. The screening procedure may be performed by (i) obtaining, by management controller agent 195 (e.g., hosted by processor 194), device data, (ii) providing the device data to management controller 152, (iii) identifying a class of device using the device data, and/or (iv) making a conclusion, based on the class of device, regarding whether other device 102A is the any known good device. Based on the screening procedure, a policy may be identified and enforced.

To initiate performance of the screening procedure, a hardware resource of hardware resources 150 (e.g., USB controller 192) may identify that other device 102A is operably connected to data processing system 100. The operable connection of device 102A to data processing system 100 may occur during a startup of data processing system 100. Refer to the description of FIG. 2A for additional details regarding identifying the connection of other device 102A during the startup.

Upon identification of the connection of other device 102A by USB controller 192, device data retrieval process 220 may be performed. During device data retrieval process 220, USB controller 192 may request and/or obtain device data from other device 102A to identify at least a type of the device. The device data may include device descriptors, and may include (i) identifiers such as a serial and/or model number, (ii) a manufacturer of other device 102A, (iii) functions of other device 102A (e.g., functionalities other device 102A is capable of performing), (iv) the type of the device (e.g., mouse, keyboard, flash drive), and/or (v) other information regarding other device 102A.

To identify at least the type of the device, USB controller 192 may provide a request for the device data to other device 102A at interaction 222 via an in-band communication channel (e.g., channel 170A). USB controller 192 may provide the request by (i) transmission via a message, (ii) storing in a storage with subsequent retrieval by other device 102A, (iii) a publish-subscribe system where other device 102A subscribes to updates from USB controller 192 thereby causing a copy of the request to be propagated to other device 102A, and/or (iv) other processes. By providing the request to other device 102A, other device 102A may provide information usable for identifying a type of the device of other device 102A.

Other device 102A may read the request and obtain a response to the request. The response may include the requested device data (e.g., the serial number, the manufacturer of other device 102A, the type of device of other device 102A). At interaction 224, the response may be provided to USB controller 192 by other device 102A via an in-band communication channel (e.g., channel 170A). The response may be provided by (i) transmission via a message, (ii) storing in a storage with subsequent retrieval by USB controller 192, (iii) a publish-subscribe system where USB controller 192 subscribes to updates from other device 102A thereby causing a copy of the response to be propagated to USB controller 192, and/or (iv) other processes.

Upon obtaining the response, USB controller 192 may provide the device data to processor 194, which may host management controller agent 195. The device data may be provided to processor 194 in order for management controller agent 195 to identify the type of the device of other device 102A. USB controller 192 may provide the device data to processor 194 automatically upon obtaining the device data, and/or USB controller 192 may provide the device data to processor 194 after receiving a request for the device data (not shown).

USB controller 192 may provide the device data to processor 194 via an in-band communication channel (e.g., channel 170B) at interaction 226. USB controller 192 may provide the device data by (i) transmission via a message, (ii) storing in a storage with subsequent retrieval by processor 194, (iii) a publish-subscribe system where processor 194 subscribes to updates from USB controller 192 thereby causing a copy of the device data to be propagated to processor 194, and/or (iv) other processes.

Management controller agent 195 hosted by processor 194 may obtain and use the device data to perform device classification process 228. During device classification process 228, management controller agent 195 may read the device data and identify the type of the device of other device 102A. The type of the device of other device 102A may be included in the device data, may be obtained by performing a lookup in a database using identifying information included in the device data as a key, and/or may be obtained from a remote system or device (e.g., a managing entity of other device 102A and/or data processing system 100, such as a manufacturer's system) based on identifying information included in the device data. For example, management controller agent 195 may provide the device data to management controller 152, which may use out-of-band communication channels to communicate with the remote system to obtain the type of the device of other device 102A (not shown).

During device classification process 228, management controller agent 195 may use the type of the device of other device 102A to identify a class of device of other device 102A. For example, the class of device may include known good devices, known bad devices, and/or indeterminant devices which may each be associated with types of devices. For example, known good devices may include types of devices which meet criteria, such as mice, keyboards, microphones, monitors, etc. Known bad devices and indeterminant devices may include types of devices which do not meet the criteria and/or devices for which the type of the device may not be determined. For additional details regarding known good devices, known bad devices, and/or indeterminant devices, refer to the discussion of FIG. 2A.

Identifying the class of device of other device 102A may include (i) using the type of the device as a key to perform a lookup in a database of classes of devices (e.g., that are keyed to at least the type of the device), (ii) using a table, list, and/or any other type of data structure to identify the class of device of other device 102A based, at least in part, on associations between the type of the device and the class of device of other device 102A, and/or (iii) other methods to obtain the class of device of other device 102A.

While described with respect to management controller agent 195 identifying the type of the device and the class of device of other device 102A, it will be appreciated that management controller 152 may perform these functions without departing from embodiments disclosed herein. For example, management controller 152 may identify the type and/or class of device of other device 102A by communicating with a remote system using an out-of-band communication channel.

Upon obtaining the class of device of other device 102A, data may be provided to management controller 152 from processor 194 at interaction 230 via a sideband communication channel (e.g., sideband channel 174B). The data may include the class of device of other device 102A and/or other identifying information for other device 102A which may be used by management controller 152 to identify a policy.

The data may be provided to management controller 152 by (i) transmission via a message, (ii) storing in a storage with subsequent retrieval by management controller 152, (iii) a publish-subscribe system where management controller 152 subscribes to updates from management controller agent 195 and/or processor 194 thereby causing a copy of the response to be propagated to management controller 152, and/or (iv) other processes.

Management controller 152 may use the data to determine whether other device 102A is any known good device. For example, management controller 152 may determine other device 102A is the any known good device if the class of device is the known good devices, and may determine other device 102A is not the any known good device if the class of device is not the known good devices (e.g., the class is the known bad devices and/or indeterminant devices).

Using the determination, management controller 152 may perform policy identification process 204 to identify a policy. Refer to the description of FIG. 2A for additional details regarding policy identification process 204.

Upon identification of the policy, management controller 152 may provide data including instructions for enforcing the policy to USB controller 192 at interaction 206 (e.g., via sideband channel 174A). The data may be used by USB controller 192 to perform policy enforcement process 208. If the action set included in the policy includes instructions to forward quarantined communications from other device 102A to a destination component, the communications (e.g., data) may be provided to the destination component (e.g., at interaction 210 via an in-band communication channel such as channel 170B). For additional details regarding policy enforcement process 208, refer to the discussion of FIG. 2A.

Thus, the processes and interactions shown in FIG. 2B may be used to perform a screening procedure by management controller 152 using management controller agent 195 to determine whether other device 102A is any known good device. Performing the screening procedure may include obtaining device data and using the device data to identify a class of device of other device 102A based at least on a type of the device of other device 102A. Based on the class of device of other device 102A, a determination may be made regarding whether other device 102A is the any known good device, and a corresponding policy may be identified and enforced.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2B may perform various methods to manage the operation of data processing systems. FIG. 3 illustrates a method that may be performed by the components of the system of FIGS. 1A-2B. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system, any component of a data processing system (e.g., a management controller, hardware resources) and/or another device.

Turning to FIG. 3, a flow diagram illustrating a method in accordance with an embodiment is shown. The flow diagram may illustrate various operations performed while managing operation of a data processing system. The data processing system may include hardware resources and a management controller, and may be similar to the data processing system discussed with respect to FIGS. 1A-1C.

At operation 300, it may be identified that a device is operably connected to the data processing system by a hardware resource of the hardware resources of the data processing system. The device may include a USB device, and a management entity of the data processing system (e.g., an operating system) may be adapted to automatically initiate operation of the device upon identification that the device is operably connected to the data processing system (e.g., when not precluded from doing so by the management controller).

Identifying that a device is operably connected to the data processing system may include (i) detecting, by a USB controller, that a device has been plugged into a USB receptacle (e.g., by detecting a change in electrical signal), (ii) providing a notification to the management controller indicating the connection of the device, and/or (iii) other methods.

At operation 302, a screening procedure may be performed using the management controller to determine whether the device is any known good device. The screening procedure may be performed during a startup of the data processing system. The hardware resources may be adapted to interact with the device during the startup (e.g., when not precluded from doing so by the management controller), which may enable the performance of the screening procedure. During the startup, the hardware resources may be in a low security state such that the hardware resources are not in a condition to screen the device for potential security threats (e.g., using a security program and/or other type of screening software).

Performing the screening procedure may include (i) obtaining, by the management controller and via a sideband channel of the data processing system, traffic data, the traffic data being usable to obtain communication patterns between the device and the hardware resources, (ii) analyzing, by the management controller and using at least one communication pattern, the traffic data to determine whether the traffic data is consistent with historical traffic patterns of the any known good device, (iii) making a conclusion, based on the analyzing, regarding whether the device is the any known good device, and/or (iv) other methods.

Obtaining the traffic data may include (i) intercepting communications sent from the device to the hardware resources prior to being received by a destination component of the hardware resources, (ii) obtaining, using the communications, metadata regarding characteristics of the communications, (iii) obtaining, based on the metadata, the at least one communication pattern, and/or (iv) other methods.

Intercepting communications sent from the device may include (i) obtaining, by the USB controller, communications from the device (e.g., via an in-band communication channel) which are intended to be sent to a destination component (e.g., a processor, a memory module), (ii) quarantining, by the USB controller, the communications (e.g., storing the communications in a local memory, preventing the communications from being forwarded to the destination component) until completion of the screening procedure, and/or (iii) other methods.

The communications may be used to obtain metadata (e.g., by the management controller) regarding characteristics of the communications (e.g., a time the communications were sent, a size of the communications, the destination component). Obtaining the metadata may include (i) receiving the metadata included in the communications (e.g., from the USB controller), (ii) reading, by the management controller, the metadata included in the communications, (iii) generating, by the management controller, the metadata based on an analysis of the communications (e.g., generalizing characteristics from the communications), and/or (iv) other methods.

Based on the metadata, the at least one communication pattern may be obtained. Obtaining the at least one communication pattern may include (i) aggregating the metadata from multiple communications from the device, (ii) analyzing the metadata to identify trends, (iii) comparing the trends to known communication patterns (e.g., from a database), (iv) selecting at least one communication pattern from the known communication patterns which is correlated with the trends, (v) providing the metadata to another device and receiving the at least one communication pattern in response, and/or (vi) other methods.

Using the at least one communication pattern, the management controller may analyze the traffic data to determine whether the traffic data is consistent with historical traffic patterns of the any known good device. Analyzing the traffic data may include (i) obtaining the historical traffic patterns of the any known good device (e.g., from a database), (ii) performing any number and/or type of similarity analyses (e.g., clustering) using the historical traffic patterns and the traffic data to obtain a result, (ii) comparing the result to similarity criteria to determine whether the result meets the similarity criteria, (iii) in a first instance in which the result meets the similarity criteria: concluding the traffic data is consistent with the historical traffic patterns of the any known good device, (iv) in a second instance in which the result does not meet the similarity criteria: concluding the traffic data is not consistent with the historical traffic patterns of the any known good device, and/or (v) other methods.

Based on the analyzing, a conclusion may be made regarding whether the device is the any known good device. Making the conclusion may include (i) determining that the device is the any known good device if the traffic data is consistent with the historical traffic patterns of the any known good device, (ii) determining that the device is not the any known good device if the traffic data is not consistent with the historical traffic patterns of the any known good device, and/or (iii) other methods.

Performing the screening procedure may also include (i) obtaining, by a management controller agent hosted by the hardware resources and via an in-band communication channel, device data, the device data being usable to identify at least a type of the device (e.g., identifiers such as a serial and/or model number, a manufacturer of the device, functions of the device, a type of the device), (ii) providing, via a sideband channel of the data processing system, the device data to the management controller (e.g., transmitting the device data via a message, storing the device data in storage with subsequent retrieval by the management controller), (iii) identifying a class of device using the device data, the class of device being associated with the type of the device, (iv) making a conclusion, based on the class of device, regarding whether the device is the any known good device, and/or (v) other methods.

Obtaining the device data may include (i) providing, by the USB controller, a request to the device for the device data (e.g., transmitting the request via a message using an in-band communication channel, storing the request in storage with subsequent retrieval by the device), (ii) receiving the device data in a response (e.g., receiving the device data in a message via an in-band communication channel, reading the device data from storage), (iii) providing the device data to the management controller agent (e.g., transmitting the device data via a message to a hardware component that hosts the management controller agent, such as a processor, storing the device data in storage with subsequent retrieval by the management controller agent), and/or (iv) other methods.

The device data may be used to identify the class of device. The class of device may include known good devices, known bad devices, and/or indeterminant devices. The class of known good devices may include devices which exhibit a level of risk that the device will act maliciously towards the data processing system that meets criteria. The class of known bad devices and the class of indeterminant devices may include devices which exhibit levels of risk that such devices will act maliciously towards the data processing system that does not meet criteria.

Identifying the class of device using the device data may include obtaining a type of the device. Obtaining the type of the device may include (i) reading the type of the device from the device data, (ii) performing a lookup in a database of types of devices using identifying information included in the device data as a key (e.g., the serial number, the manufacturer of the device), (iii) providing the device data to another entity and receiving the type of the device in response, and/or (iv) other methods.

The type of the device may be used to identify the class of device. Using the type of the device to identify the class of device may include (i) using the type of the device as a key to perform a lookup in a database of classes of devices (e.g., that are keyed to at least the type of the device), (ii) using a table, list, and/or any other type of data structure to identify the class of device based, at least in part, on associations between the type of the device and the class of device, (iii) providing the type of the device to another entity and receiving the class of device in response, and/or (iv) other methods.

Making the conclusion, based on the class of device, regarding whether the device is the any known good device may include (i) determining that the device is the any known good device if the class of device is the known good devices, (ii) determining that the device is not the any known good device if the class of device is not the known good devices (e.g., the class is the known bad devices and/or indeterminant devices), (iii) providing the class of device to another entity and receiving the conclusion in response, and/or (iv) other methods.

At operation 304, it may be determined whether the device is the any known good device. Making the determination may include (i) parsing the conclusion to ascertain whether it indicates the device is the any known good device, (ii) providing the conclusion to another entity and receiving a response indicating whether the device is the any known good device, and/or (iii) other methods.

If it is determined that the device is not the any known good device (e.g., the determination is “No” at operation 304), then the method may proceed to operation 306.

At operation 306, the device may be denied access to the data processing system to reduce an impact of the device on the operation of the data processing system. Denying the device access to the data processing system may include (i) ignoring future communications from the device, (ii) quarantining communications from the device, (iii) providing a notification to the device indicating the device has been denied access to the data processing system, and/or (iv) other methods.

The method may end following operation 306.

Returning to operation 304, if it is determined that the device is the any known good device (e.g., the determination is “Yes” at operation 304), then the method may proceed to operation 308.

At operation 308, the device may be allowed access to the data processing system to perform functions of the device. Allowing the device access to the data processing system may include (i) forwarding any quarantined communications from the device to the destination component, (ii) facilitating communication between the device and hardware resources of the data processing system, (iii) providing a notification to the device indicating the device has been allowed access to the data processing system and/or (iv) other actions.

At operation 310, computer-implemented services may be provided using the device. Providing the computer-implemented services using the device may include utilizing the functions of the device in the provision of the computer-implemented services and/or other methods.

The method may end following operation 310.

Thus, as illustrated above, embodiments disclosed herein may provide systems and methods usable to manage operation of a data processing system using out-of-band components (e.g., a management controller) to facilitate use of USB devices. The management controller may perform a screening procedure to screen the USB devices for potential threats independently and/or cooperatively with hardware resources of the data processing system. By doing so, USB devices may be screened without relying on (potentially compromised and/or disabled) in-band components.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
identifying, by a hardware resource of hardware resources of the data processing system, that a device is operably connected to the data processing system;
performing, using a management controller of the data processing system, a screening procedure to determine whether the device is any known good device;
in a first instance of the screening procedure in which the device is not the any known good device:
denying the device access to the data processing system to reduce an impact of the device on the operation of the data processing system;
in a second instance of the screening procedure in which the device is the any known good device:
allowing the device access to the data processing system to perform functions of the device; and
providing, using the device, computer-implemented services.

2. The method of claim 1, wherein performing the screening procedure comprises:
obtaining, by the management controller and via a sideband channel of the data processing system, traffic data, the traffic data being usable to obtain communication patterns between the device and the hardware resources;
analyzing, by the management controller and using at least one communication pattern, the traffic data to determine whether the traffic data is consistent with historical traffic patterns of the any known good device; and
making a conclusion, based on the analyzing, regarding whether the device is the any known good device.

3. The method of claim 2, wherein obtaining the traffic data comprises:
intercepting communications sent from the device to the hardware resources prior to being received by a destination component of the hardware resources;
obtaining, using the communications, metadata regarding characteristics of the communications; and
obtaining, based on the metadata, the at least one communication pattern.

4. The method of claim 3, wherein the communications sent from the device are not provided to the destination component of the hardware resources until completion of the screening procedure.

5. The method of claim 1, wherein performing the screening procedure comprises:
obtaining, by a management controller agent hosted by the hardware resources and via an in-band communication channel, device data, the device data being usable to identify at least a type of the device;
providing, via a sideband channel of the data processing system, the device data to the management controller;
identifying a class of device using the device data, the class of device being associated with the type of the device; and
making a conclusion, based on the class of device, regarding whether the device is the any known good device.

6. The method of claim 1, wherein the any known good device comprises a device that is not an any known bad device and is not any indeterminant device.

7. The method of claim 6, wherein the any known good device exhibits a level of risk that the device will act maliciously towards the data processing system that meets criteria, and the any known bad device and the any indeterminant device exhibit levels of risk that such devices will act maliciously towards the data processing system that does not meet the criteria.

8. The method of claim 1, wherein the management controller is on a separate power domain from the hardware resources so that the management controller is operable while the hardware resources are inoperable.

9. The method of claim 8, wherein the screening procedure is performed during a startup of the data processing system.

10. The method of claim 9, wherein the hardware resources are adapted to interact with the device during the startup when not precluded from doing so by the management controller.

11. The method of claim 10, wherein the hardware resources are in a low security state during the startup such that the hardware resources are not in a condition to screen the device for potential security threats.

12. The method of claim 1, wherein the management controller is separate from and tasked with managing operation of the hardware resources, and commands issued by the management controller override commands issued by the hardware resources.

13. The method of claim 1, wherein the device is a universal serial bus (USB) device, and a management entity of the data processing system is adapted to automatically initiate operation of the device upon identification that the device is operably connected to the data processing system when not precluded from doing so by the management controller.

14. The method of claim 1, wherein the hardware resource is a USB controller, and the device is operably connected to the data processing system via a USB receptacle.

15. A non-transitory machine-readable medium having instructions stored therein, which when executed by a processor, cause the processor to perform operations for managing operation of a data processing system, the operations comprising:
identifying, by a hardware resource of hardware resources of the data processing system, that a device is operably connected to the data processing system;
performing, using a management controller of the data processing system, a screening procedure to determine whether the device is any known good device;
in a first instance of the screening procedure in which the device is not the any known good device:
denying the device access to the data processing system to reduce an impact of the device on the operation of the data processing system;
in a second instance of the screening procedure in which the device is the any known good device:
allowing the device access to the data processing system to perform functions of the device; and
providing, using the device, computer-implemented services.

16. The non-transitory machine-readable medium of claim 15, wherein performing the screening procedure comprises:
obtaining, by the management controller and via a sideband channel of the data processing system, traffic data, the traffic data being usable to obtain communication patterns between the device and the hardware resources;
analyzing, by the management controller and using at least one communication pattern, the traffic data to determine whether the traffic data is consistent with historical traffic patterns of the any known good device; and
making a conclusion, based on the analyzing, regarding whether the device is the any known good device.

17. The non-transitory machine-readable medium of claim 16, wherein obtaining the traffic data comprises:
intercepting communications sent from the device to the hardware resources prior to being received by a destination component of the hardware resources;
obtaining, using the communications, metadata regarding characteristics of the communications; and
obtaining, based on the metadata, the at least one communication pattern.

18. A data processing system, comprising:
a processor; and
a memory coupled to the processor to store instructions, which when executed by the processor, cause the processor to perform operations for managing operation of a data processing system, the operations comprising:
identifying, by a hardware resource of hardware resources of the data processing system, that a device is operably connected to the data processing system;
performing, using a management controller of the data processing system, a screening procedure to determine whether the device is any known good device;
in a first instance of the screening procedure in which the device is not the any known good device:
denying the device access to the data processing system to reduce an impact of the device on the operation of the data processing system;
in a second instance of the screening procedure in which the device is the any known good device:
allowing the device access to the data processing system to perform functions of the device; and
providing, using the device, computer-implemented services.

19. The data processing system of claim 18, wherein performing the screening procedure comprises:
obtaining, by the management controller and via a sideband channel of the data processing system, traffic data, the traffic data being usable to obtain communication patterns between the device and the hardware resources;
analyzing, by the management controller and using at least one communication pattern, the traffic data to determine whether the traffic data is consistent with historical traffic patterns of the any known good device; and
making a conclusion, based on the analyzing, regarding whether the device is the any known good device.

20. The data processing system of claim 19, wherein obtaining the traffic data comprises:
intercepting communications sent from the device to the hardware resources prior to being received by a destination component of the hardware resources;
obtaining, using the communications, metadata regarding characteristics of the communications; and
obtaining, based on the metadata, the at least one communication pattern.
